(19) United States
(12) Patent Application Publication
(10) Pub. No.: US 2025/0046925 A1
(43) Pub. Date: Feb. 6, 2025

(54) UNIT CELL

(71) Applicant: TOYOTA JIDOSHA KABUSHIKI KAISHA, Toyota-shi (JP)

(72) Inventor: Yushi SUZUKI, Mishima-shi (JP)

(73) Assignee: TOYOTA JIDOSHA KABUSHIKI KAISHA, Toyota-shi (JP)

(21) Appl. No.: 18/644,471

(22) Filed: Apr. 24, 2024

(30) Foreign Application Priority Data
Aug. 2, 2023 (JP) 2023-126347

(51) Int. Cl. H01M 50/186; H01M 10/04

(52) U.S. Cl. CPC H01M 50/186; H01M 10/0454; H01M 2300/0065

(57) ABSTRACT

A unit cell in which a first current collector layer, a first electrode active material layer, an electrolyte layer, a second electrode active material layer, and a second current collector layer are laminated in this order, wherein the first electrode active material layer is laminated only on the inner region, and the second current collector layer is folded so as to enclose the electrolyte layer and the second electrode active material layer, and is joined to the first current collector layer via an insulating sealing member on the peripheral region to form a joint portion, thereby sealing the first electrode active material layer, the electrolyte layer, and the second electrode active material layer with the first current collector layer, the insulating sealing member, and the second current collector layer.

### CROSS-REFERENCE TO RELATED APPLICATION

This application claims priority to Japanese Patent Application No. 2023-126347 filed on Aug. 2, 2023, incorporated herein by reference in its entirety.

### BACKGROUND

### 1. Technical Field

The present disclosure relates to a thin unit cell.

### 2. Description of Related Art

In recent years, there has been a demand to reduce the thickness and the size of batteries mounted on portable devices etc. along with the reduction in the thickness of such devices. As a thin battery, there is known a battery in which a unit cell is sandwiched between two laminate films and end portions are thermally fused to seal the end portions. This thin battery can suppress deterioration of the battery due to moisture by sealing the end portions. Since the sealed portion is irrelevant to charge and discharge, however, the sealed portion is required to be as small as possible from the viewpoint of energy density. The following power storage device and so forth are disclosed as thin and small batteries in which the sealed portion is made as small as possible.

For example, Japanese Unexamined Patent Application Publication No. 2019-021636 (JP 2019-021636 A) discloses a power storage device sheet including: a positive electrode-side sheet body including a first metal foil layer, a positive electrode active material layer stacked on a part of region of one surface of the first metal foil layer, a first thermoplastic resin layer provided at a peripheral edge portion of the one surface of the first metal foil layer where the positive electrode active material layer is not formed, and a first insulating resin film layer stacked on the other surface of the first metal foil layer; a negative electrode-side sheet body including a second metal foil layer, a negative electrode active material layer stacked on a part of region of one surface of the second metal foil layer, a second thermoplastic resin layer provided at a peripheral edge portion of the one surface of the second metal foil layer where the negative electrode active material layer is not formed, and a second insulating resin film layer stacked on the other surface of the second metal foil layer; a separator disposed between the positive electrode-side sheet body and the negative electrode-side sheet body, in which: the positive electrode active material layer is disposed between the first metal foil layer and the separator, and the negative electrode active material layer is disposed between the second metal foil layer and the separator; the first thermoplastic resin layer of the positive electrode-side sheet body and the second thermoplastic resin layer of the negative electrode-side sheet body are fused to form a peripheral edge scaling layer to integrate a stack of the two sheet bodies; an electrolytic solution is sealed between the separator and the positive electrode active material layer, and an electrolytic solution is sealed between the separator and the negative electrode active material layer; and a peripheral edge portion of the separator enters and engages with an intermediate portion, in the thickness direction, of the inner peripheral surface of the peripheral edge sealing layer. According to the power storage device sheet according to JP 2019-021636 A, the first metal foil layer constituting the positive electrode portion and the second metal foil layer constituting the negative electrode portion also function as an exterior material of the power storage device, that is, the first and second metal foil layers function as both the electrode and the exterior material. Thus, no additional exterior material is required for the present configuration (the conventional exterior material is not necessary), and thus it is considered that the weight and the thickness of the power storage device and the space required for the power storage device can be reduced, and that the cost of the power storage device also can be reduced.

Japanese Unexamined Patent Application Publication No. 2013-114929 (JP 2013-114929 A) discloses a thin battery including: a power generation element; two exterior bodies for sealing the power generation element; a positive electrode current collector terminal connected to a positive electrode current collector of the power generation element and covering at least a part of at least one of both outside surfaces, in the stacking direction, of the power generation element; and a negative electrode current collector terminal connected to a negative electrode current collector of the power generation element and covering at least a part of at least one of both outside surfaces, in the stacking direction, of the power generation element, in which: first bonding is performed in which at least sides of the outer periphery of the power generation element provided with the positive electrode current collector and the negative electrode current collector are wrapped by one or both of the two exterior bodies being folded and the two exterior bodies are bonded to each other on both outside surfaces, in the stacking direction, of the power generation element; second bonding is performed in which the two exterior bodies are bonded to each other on sides of the outer periphery of the power generation element around the stacking direction of the power generation element not wrapped by the two folded exterior bodies; and surfaces bonded in the first bonding are greater than surfaces bonded in the second bonding. According to the thin battery according to JP 2013-114929 A, the two exterior bodies are bonded to each other on both outside surfaces, in the stacking direction, of the power generation element at least partially covered by the positive electrode current collector terminal and the negative electrode current collector terminal, and thus it is considered that the seal strength of portions provided with the positive electrode current collector terminal and the negative electrode current collector terminal can be enhanced. Further, even when a conductive member is stuck from the outside of the battery, a current flows from the positive electrode current collector to the negative electrode current collector via the positive electrode current collector terminal, the conductive member, and the negative electrode current collector terminal, and thus it is considered that an increase in the battery temperature can be suppressed by suppressing concentration of a current at an internal short-circuited portion.

### SUMMARY

In these prior art techniques, it is considered that the current collectors, the laminate films, and so forth are folded by enclosing the electrode active material layers and so forth, so that the sealed portion can be made small and thereby the energy density per unit area can be improved. However, it is considered that the thickness of the cell increases due to the folded portion and the sealed portion, and therefore there is room for improvement in the energy density per unit volume.

Therefore, an object of the present disclosure is to provide a unit cell capable of improving an energy density per unit area and an energy density per unit volume.

The present disclosure achieves the above object by the following means.

### First Aspect

A unit cell including a first current collector layer, a first electrode active material layer, an electrolyte layer, a second electrode active material layer, and a second current collector layer stacked in this order, in which:
the electrolyte layer and the second electrode active material layer have a peripheral region and an inside region located inside the peripheral region when viewed in a stacking direction of the layers constituting the unit cell;
the first electrode active material layer is stacked only on the inside region; and
the second current collector layer is folded so as to enclose the electrolyte layer and the second electrode active material layer, and is joined to the first current collector layer via an insulating sealing member on the peripheral region to form a joint portion, thereby sealing the first electrode active material layer, the electrolyte layer, and the second electrode active material layer with the first current collector layer, the insulating sealing member, and the second current collector layer.

### Second Aspect

The unit cell according to the first aspect, in which a thickness of the joint portion of the first current collector layer, the insulating sealing member, and the second current collector layer in the stacking direction is equal to or smaller than a total thickness of the first current collector layer and the first electrode active material layer.

### Third Aspect

The unit cell according to the first aspect, in which the first current collector layer, the insulating sealing member, and the second current collector layer are stacked in the joint portion in an order of the first current collector layer, the insulating sealing member, and the second current collector layer from a side farther from the electrolyte layer.

### Fourth Aspect

The unit cell according to the first aspect, in which the first current collector layer, the insulating sealing member, and the second current collector layer are stacked in the joint portion in an order of the second current collector layer, the insulating sealing member, and the first current collector layer from a side farther from the electrolyte layer.

### Fifth Aspect

The unit cell according to any one of the first to fourth aspects, in which the electrolyte layer is a solid electrolyte layer.

### Sixth Aspect

A method of manufacturing a unit cell including a first current collector layer, a first electrode active material layer, an electrolyte layer, a second electrode active material layer, and a second current collector layer stacked in this order, including:
providing a stack of a first current collector layer, a first electrode active material layer, an electrolyte layer, a second electrode active material layer, and a second current collector layer, in which the electrolyte layer and the second electrode active material layer have a peripheral region and an inside region located inside the peripheral region when viewed in a stacking direction of the layers constituting the unit cell, and the first electrode active material layer is stacked only on the inside region; and
folding the second current collector layer so as to enclose the electrolyte layer and the second electrode active material layer, and joining the second current collector layer to the first current collector layer via an insulating sealing member on the peripheral region to form a joint portion, thereby sealing the first electrode active material layer, the electrolyte layer, and the second electrode active material layer with the first current collector layer, the insulating sealing member, and the second current collector layer.

According to the present disclosure, it is possible to provide a unit cell capable of improving an energy density per unit area and an energy density per unit volume.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic view illustrating a first electrode active material layer, an electrolyte layer, and a second electrode active material layer of a unit cell according to the present disclosure;

FIG. 1B is a schematic view illustrating a first electrode active material layer, an electrolyte layer, and a second electrode active material layer of a unit cell according to the present disclosure;

FIG. 2 is a schematic cross-sectional view for explaining a first electrode active material layer, an electrolyte layer, and a second electrode active material layer of a unit cell of the present disclosure;

FIG. 3 is a schematic cross-sectional view for describing a unit cell of the present disclosure;

FIG. 4 is a schematic cross-sectional view for describing a unit cell of another embodiment of the present disclosure;

FIG. 5A is a schematic cross-sectional view illustrating a unit cell manufactured in Example 1;

FIG. 5B is a schematic cross-sectional view illustrating a unit cell manufactured in Example 1;

FIG. 5C is a schematic cross-sectional view illustrating a unit cell manufactured in Example 1;

FIG. 5D is a schematic cross-sectional view illustrating a unit cell manufactured in Example 1;

FIG. 6A is a schematic cross-sectional view of a unit cell other than the unit cell of the present disclosure, the unit cell having an end portion sealed by an insulating sealing member, and the unit cell having a sealing portion in a stacking direction; and

FIG. 6B is a schematic cross-sectional view illustrating a unit cell other than the unit cell of the present disclosure, in which an end portion is sealed by an insulating sealing member, and a unit cell having a sealing portion in a stacking direction.

### DETAILED DESCRIPTION OF EMBODIMENTS

Hereinafter, embodiments of the present disclosure will be described in detail. Note that the present disclosure is not limited to the following embodiments, and various modifications can be made within the scope of the gist of the present disclosure. In the description of the drawings, the same elements are denoted by the same reference numerals, and redundant description will be omitted.

### Unit Cell

The unit cell of the present disclosure is
a unit cell comprising a first current collector layer, a first electrode active material layer, an electrolyte layer, a second electrode active material layer, and a second current collector layer stacked in this order.
When viewed from the stacking direction of each layer constituting the unit cell, the electrolyte layer and the second electrode active material layer has a peripheral region and an inner region inside the peripheral region.
The first electrode active material layer is laminated only on the inner region.
The 2 current collector layer is folded so as to enclose the electrolyte layer and the 2 electrode active material layer, and is joined to the 1 current collector layer via an insulating scaling member on the peripheral region to form a joint portion, whereby the 1 current collector layer, the insulating sealing member, and the 2 current collector layer seal the 1 electrode active material layer, the electrolyte layer, and the 2 electrode active material layer.
It is a unit cell.

According to the present disclosure, it is possible to provide a unit cell capable of improving an energy density per unit area and an energy density per unit volume.

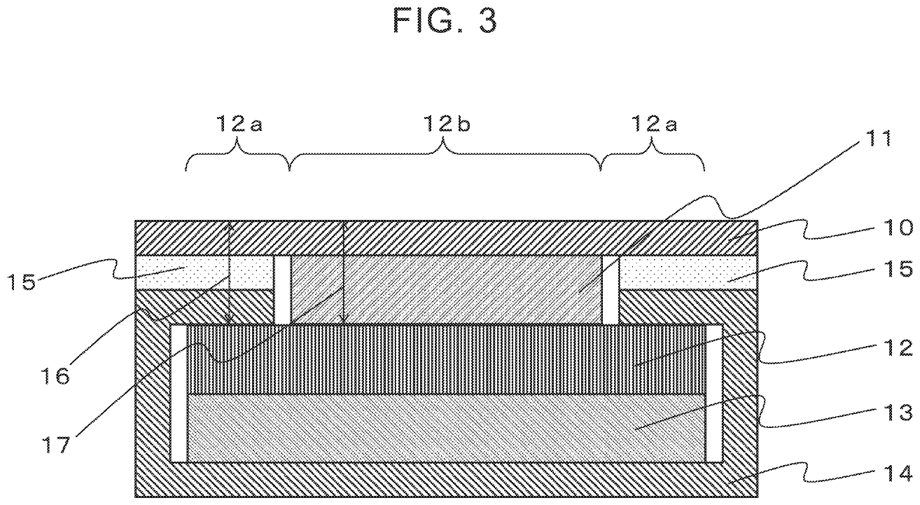

Specifically, for example, as shown in FIG. 3, in the unit cell of the present disclosure, the electrolyte layer 12 and the second electrode active material layer 13 are enclosed by the second current collector layer 14, and the first current collector layer 10 and the second current collector layer 14 form a joint portion by the insulating sealing member 15 on the peripheral region 12a of the electrolyte layer 12, whereby the first electrode active material layer 11, the electrolyte layer 12, and the second electrode active material layer 13 are sealed.

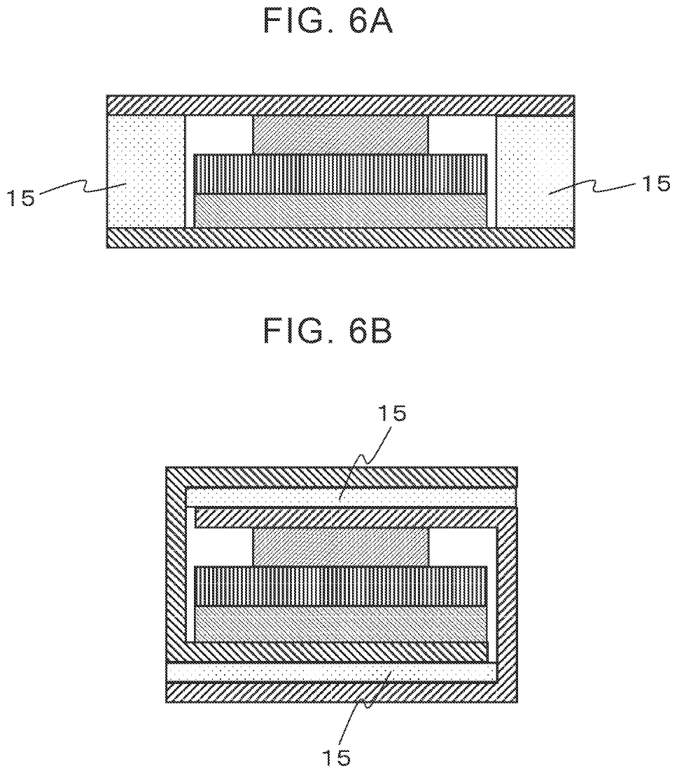

By enclosing the electrode stack in the second current collector layer 14, the area of the insulating sealing member can be reduced as compared with a battery in which the periphery of the electrode stack is sealed with an insulating sealing member, specifically, for example, FIG. 6A, and the area of the first electrode active material layer and the second electrode active material layer occupying the area of the unit cell can be increased. Accordingly, it is considered that when the electrode stack having the same energy density is used, the energy density per unit area of the unit cell can be improved.

Further, the first current collector layer 10 and the second current collector layer 14 form a joint portion on the peripheral region 12a of the electrolyte layer 12. That is, the joint portion is disposed at a position in parallel with at least a portion of the first electrode active material layer 11 in the thickness direction. Therefore, the current collector layer is wound and sealed in the lamination direction. More specifically, compared to, for example, FIG. 6B, the disclosed unit cell can be suppressed from increasing in thickness. Accordingly, it is considered that when an electrode stack having the same energy density is used, the energy density per unit volume of the unit cell can be improved.

### Laminate of First Electrode Active Material Layer, Electrolyte Layer, and Second Electrode Active Material Layer

In the unit cell of the present disclosure,
When viewed from the stacking direction of each layer constituting the unit cell, the electrolyte layer and the second electrode active material layer has a peripheral region and an inner region inside the peripheral region,
The first electrode active material layer is laminated only on the inner region.

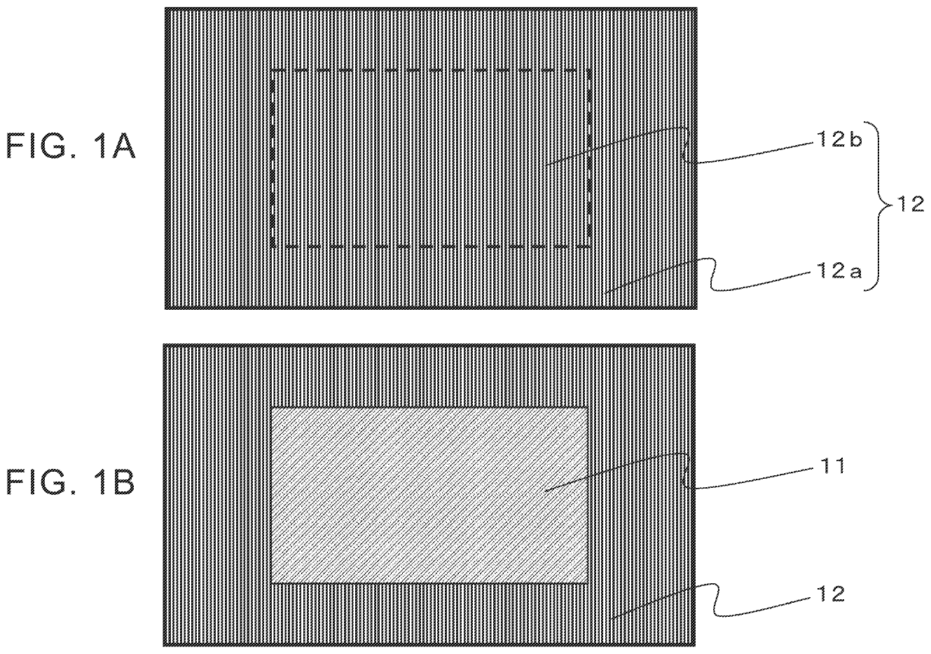

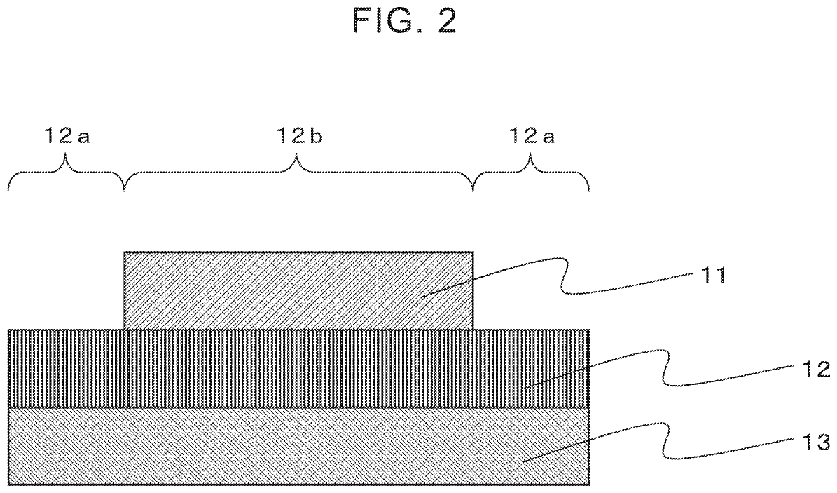

FIG. 1A is an example of a schematic diagram when a stack of an electrolyte layer and a second electrode active material layer of a unit cell of the present disclosure is viewed from a stacking direction, and FIG. 1B is an example of a schematic diagram when a stack of a first electrode active material layer, an electrolyte layer, and a second electrode active material layer of a unit cell of the present disclosure is viewed from a stacking direction, but is not limited to this. FIG. 2 is one example of a cross-sectional schematic diagram illustrating a stack of a first electrode active material layer, an electrolyte layer, and a second electrode active material layer of a unit cell of the present disclosure, but is not limited thereto.

A laminate of a first electrode active material layer, an electrolyte layer, and a second electrode active material layer will be described with reference to FIG. 1A, FIG. 1B, and FIG. 2. In the schematic diagram when viewed from the stacking direction of FIG. 1A, in the stack of the electrolyte layer 12 and the second electrode active material layer 13, the electrolyte layer 12 and the second electrode active material layer 13 have a peripheral region 12a outside the dotted line illustrated in the electrolyte layer 12 and an inner region 12b inside the dotted line. In the schematic view of FIG. 1B, the first electrode active material layer 11 is stacked only on the inner region 12b of the electrolyte layer. The area of the first electrode active material layer 11 is smaller than that of the electrolyte layer 12 and the second electrode active material layer 13 because it is stacked only on the inner region 12b. In the cross-sectional view of FIG. 3, since the first electrode active material layer 11 is not laminated on the peripheral region 12a of the electrolyte layer 12, the laminated body in which the first electrode active material layer 11, the electrolyte layer 12, and the second electrode active material layer 13 are laminated has a convex shape.

Encapsulation with a Second Current Collector Layer and a First Current Collector Layer

The second current collector layer of the present disclosure is folded so as to enclose the electrolyte layer and the second electrode active material layer, and is joined to the first current collector layer via an insulating sealing member to form a joint portion on the peripheral region, thereby sealing the first electrode active material layer, the electrolyte layer, and the second electrode active material layer with the first current collector layer, the insulating sealing member, and the second current collector layer.

### Insulating Sealing Member

The insulating sealing member may be made of any material capable of bonding the first current collector layer and the second current collector layer and electrically insulating them.

The insulating sealing member is not particularly limited, but a thermoplastic resin, a rubber, a non-conductive binder, or the like can be used. Specific examples of the thermoplastic resin include, but are not limited to, polyethylene terephthalate (PET), polypropylene (PP), polyvinylidene chloride (PVDC), polyvinylidene fluoride (PVDF), polycarbonate (PC), and polyetherimide (PEI). Specific examples of the rubber include acrylonitrile butadiene rubber (ABR) and butadiene rubber (SB), but are not limited thereto. Specific examples of the non-conductive binder include, but are not limited to, an epoxy-based binder and an acrylic-based binder. The insulating sealing member may be an insulating metal oxide, for example, alumina, zirconia, calcium oxide, or magnesium oxide. Any combination of the above-described materials may also be used.

FIG. 3 is one example, but not limited to, of a schematic cross-sectional view of a unit cell of the present disclosure.

A second current collector layer 14 is provided under the stack of the first electrode active material layer 11, the electrolyte layer 12, and the second electrode active material layer 13. The second current collector layer 14 is folded so as to enclose the electrolyte layer 12 and the second electrode active material layer 13. The folded end portion of the second current collector layer 14 is disposed on the peripheral region 12a of the electrolyte layer 12 and is not contacted with the first electrode active material layer 11. An insulating sealing member 15 is provided on the folded end of the second current collector layer 14, and a first current collector layer 10 is provided on the insulating sealing member. The first current collector layer 10 is disposed in contact with the insulating sealing member 15 and the first electrode active material layer 11. A joint portion is formed by the first current collector layer 10, the insulating sealing member 15, and the second current collector layer 14. Thereby, the first electrode active material layer 11, the electrolyte layer 12, and the second electrode active material layer 13 are sealed by the first current collector layer 10, the insulating sealing member 15, and the second current collector layer 14. Since the joint portion is on the peripheral region 12a of the electrolyte layer 12, it is considered that the thickness of the unit cell by the insulating sealing member or the current collector layer is suppressed and the energy-density per unit volume of the unit cell is improved even though the unit cell of the present disclosure includes the electrode active material layer and the electrolyte layer by the current collector layer.

The folded end portion of the second current collector is not particularly limited, but may be present in the peripheral region 12a of the electrolyte layer 12, may be in contact with the electrolyte layer 12, or may be in contact with another member such as an insulating sealing member. The width of the joint portion is not particularly limited from the viewpoint of preventing degradation of the battery due to moisture, but is preferably 1 mm or more, 2 mm or more, 3 mm or more, 4 mm or more, or 5 mm or more. Further, the range of the joint portion may be 30 mm below, 20 mm below, 10 mm below, 5 mm below, or 3 mm below.

### Components of the Unit Cell

In the unit cell of the present disclosure, the first current collector layer, the first electrode active material layer, the electrolyte layer, the second electrode active material layer, and the second current collector layer are stacked in this order.

### First Current Collector Layer

The material used for the first current collector layer is not particularly limited, but a material that can be used as a current collector of a battery can be appropriately employed.

For example, the material used for the first current collector layer may be, but is not limited to, stainless steel (SUS), aluminum, copper, nickel, iron, titanium, carbon, or a conductive resin. In addition, a metal such as aluminum, copper, SUS, nickel, iron, or titanium may be coated with carbon, plated with carbon, or may be treated by vapor deposition or the like.

When the first current collector layer is a positive electrode current collector, the material used for the first current collector layer is not particularly limited, but a current collector having oxidation resistance is preferable, and aluminum is more preferable. When the first current collector layer is a negative electrode current collector, the material used for the first current collector layer is not particularly limited, but a current collector having reduction resistance is preferable, and nickel is more preferable.

The shape of the first current collector layer may be any shape that can be joined with the second current collector layer to form an outer package. Such a shape may be, for example, a foil shape, but is not particularly limited.

The first current collector layer is preferably made of a material that is less likely to transmit moisture from the viewpoint of forming an exterior body.

### First Electrode Active Material Layer

The first electrode active material layer may be a negative electrode active material layer or a positive electrode active material layer.

The first electrode active material layer may contain an electrode active material, and optionally a solid electrolyte, a conductive aid, and a binder.

When the first electrode active material layer is a positive electrode active material layer, the electrode active material is a positive electrode active material.

The material of the positive electrode active material is not particularly limited. For example, the positive electrode active material may be lithium cobalt oxide (LiCoO₂), Lithium nickel oxide (LiNiO₂), lithium manganese oxide (LiMn₂O₄), LiCo_{1/3}Ni_{1/3}Mn_{1/3}O₂, a heteroelement-substituted Li−Mn spinel having a composition represented by Li₁₊ₓMn_{2-x-y}M_{y}O₄ (M is at least one metal element selected from among Al, Mg, Co, Fe, Ni, and Zn), or the like, but is not limited thereto.

When the first electrode active material layer is a negative electrode active material layer, the electrode active material is a negative electrode active material.

The material of the negative electrode active material is not particularly limited, and may be metallic lithium or a material capable of occluding and releasing metallic ions such as lithium ions. Examples of materials capable of occluding and releasing metal ions such as lithium ions include alloy-based negative electrode active materials and carbon materials, but are not limited to these.

The alloy-based negative electrode active material is not particularly limited, and examples thereof include a Si alloy-based negative electrode active material, a Sn alloy-based negative electrode active material, and the like. The Si alloy-based negative electrode active materials include silicon, silicon oxides, silicon carbides, silicon nitrides, solid solutions thereof, and the like. In addition, the Si alloy-based negative electrode active material can contain elements other than silicon, such as Fe, Co, Sb, Bi, Pb, Ni, Cu, Zn, Ge, In, Sn, and Ti. The Sn alloy-based negative electrode active materials include tin, tin oxide, tin nitride, solid solutions thereof, and the like. In addition, the Sn alloy-based negative electrode active material can contain elements other than tin, such as Fe, Co, Sb, Bi, Pb, Ni, Cu, Zn, Ge, In, Ti, and Si. Among the above, the Si alloy-based negative electrode active materials are preferred.

The carbon material is not particularly limited, and examples thereof include hard carbon, soft carbon, graphite, and the like.

### Solid Electrolyte

The material of the solid electrolyte is not particularly limited, and for example, the solid electrolyte may be a sulfide solid electrolyte, an oxide solid electrolyte, a polymer electrolyte, or the like, but is not limited thereto.

Examples of sulfide solid electrolyte include, but are not limited to, a sulfide-based amorphous solid electrolyte, a sulfide-based crystalline solid electrolyte, an aldirodite-type solid electrolyte, and the like. Specific examples of sulfide solid electrolyte include Li₂S—P₂S₅-based materials (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, etc.; or combinations thereof, but are not limited to these.

Examples of oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, Li₃₊ₓPO₄₋ₓNₓ(LiPON), but are not limited to these.

The sulfide solid electrolyte and oxide solid electrolyte may be glass or crystallized glass (glass ceramic).

Examples of polymer electrolytes include polyethylene oxide (PEO), polypropylene oxide (PPO), copolymers thereof and the like, but are not limited to these.

### Conductive Aid

The conductive aid is not particularly limited. For example, the conductive aid may be a carbon material such as a vapor grown carbon fiber (VGCF) and a carbon nanofiber, a metal material, or the like, but the present disclosure is not limited thereto.

### Binder

The binder is not particularly limited. For example, examples of the binder include materials such as polyvinylidene fluoride (PVdF), butadiene rubber (BR), polytetrafluoroethylene (PTFE) or styrene butadiene rubber (SBR), or combinations thereof, but are not limited to these.

### Electrolyte Layer

The electrolyte layer of the present disclosure may be a solid electrolyte layer.

When the electrolyte layer is a solid electrolyte layer, the solid electrolyte layer may contain a binder or the like as necessary in addition to the solid electrolyte. Note that the solid electrolyte and the binder can refer to the description regarding the “first electrode active material layer” described above.

### Second Electrode Active Material Layer

For the second electrode active material layer, the description of the “first electrode active material layer” described above can be referred to.

Note that the first electrode active material layer and the second electrode active material layer have opposite poles. That is, if the first electrode active material layer is a positive electrode active material layer, the second electrode active material layer is a negative electrode active material layer. Similarly, if the first electrode active material layer is a negative electrode active material layer, the second electrode active material layer is a positive electrode active material layer.

### Second Current Collector Layer

The second current collector layer may be formed from the materials described in the “first current collector layer” above.

The shape of the second current collector layer may be any shape capable of winding the laminate so as to enclose the laminate of the first electrode active material layer, the electrolyte layer, and the second electrode active material layer. Examples of such a shape include, but are not limited to, a foil shape.

Note that the first current collector layer and the second current collector layer have opposite poles. That is, if the first current collector layer is a positive electrode current collector layer, the second current collector layer is a negative electrode current collector layer. Similarly, if the first current collector layer is a positive electrode current collector layer, the second current collector layer is a negative electrode current collector layer.

### Thickness of the Joint Portion

The thickness of each member of the unit cell of the present disclosure may be the same as or smaller than the total thickness of the first current collector layer and the first electrode active material layer in the thickness of the joint portion of the first current collector layer, the insulating sealing member, and the second current collector layer in the stacking direction. For example, the thickness of the joint portion of the first current collector layer, the insulating sealing member, and the second current collector layer may be 100% or less, 95% or less, 90% or less, or 85% or less, and may be 50% or more, 60% or more, 70% or more, or 80% or more, of the total thickness of the first current collector layer and the first electrode active material layer.

In view of suppressing an increase in the thickness of the unit cell due to the presence of the joint portion on the peripheral region, the thickness of the joint portion is not particularly limited, but is preferably the same as or smaller than the total thickness of the first current collector layer and the first electrode active material layer. Here, the thickness of the joint portion is the total thickness of the first current collector layer, the insulating sealing member, and the second current collector layer.

For example, in FIG. 3 described above, the total thickness 16 of the joint portion is the total thickness of the first current collector layer 10, the insulating sealing member 15, and the second current collector layer 14, and the total thickness 17 of the first current collector layer and the first electrode active material layer is the total thickness of the first current collector layer 10 and the first electrode active material layer 11.

### Insulating Lashing Member

The unit cell may further include an insulating lashing member. For specific materials of the insulating lashing member, reference can be made to the description of the “insulating sealing member”.

### Aspect of the Joint Portion

In the unit cell of the present disclosure, the first current collector layer, the insulating sealing member, and the second current collector layer may be laminated in the order of the first current collector layer, the insulating sealing member, and the second current collector layer from a side far from the electrolyte layer in the joint portion.

For example, in the above-described unit cell of FIG. 3, a joint portion formed of the first current collector layer 10, the insulating sealing member 15, and the second current collector layer 14 is provided on the peripheral region 12a of the electrolyte layer 12. In FIG. 3, the first current collector layer 10, the insulating sealing member 15, and the second current collector layer 14 are stacked in this order from the side far from the electrolyte layer 12. Note that the second current collector layer 14 close to the electrolyte layer 12 may be in direct contact with the electrolyte layer 12, or may be in contact with another member such as an insulating lashing member.

### Another Aspect of the Joint Portion

In the unit cell of the present disclosure, the first current collector layer, the insulating sealing member, and the second current collector layer may be laminated in the order of the second current collector layer, the insulating sealing member, and the first current collector layer from a side far from the electrolyte layer in the joint portion.

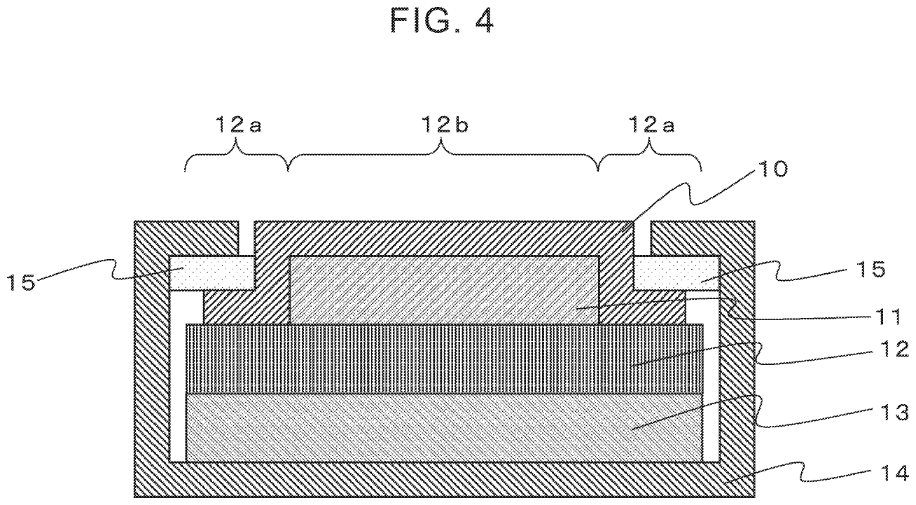

FIG. 4 is one example, but not limited to, of a schematic cross-sectional view of a unit cell of the present disclosure.

On the peripheral region 12a of the electrolyte layer 12, a joint portion formed of the first current collector layer 10, the insulating sealing member 15, and the second current collector layer 14 is provided. In FIG. 4, the second current collector layer 14, the insulating sealing member 15, and the first current collector layer 10 are stacked in this order from the side far from the electrolyte layer 12. The first current collector layer 10 close to the electrolyte layer 12 may be in direct contact with the electrolyte layer 12 or may be in contact with another member such as an insulating lashing member.

### Method of Manufacturing Unit Cell

A method of manufacturing a unit cell of the present disclosure is a method of manufacturing a unit cell in which a first current collector layer, a first electrode active material layer, an electrolyte layer, a second electrode active material layer, and a second current collector layer are laminated in this order.

To provide a laminate of a 1 current collector layer, a 1 electrode active material layer, an electrolyte layer, a 2 electrode active material layer, and a 2 current collector layer. Here, when viewed from the stacking direction of each layer constituting the unit cell, the electrolyte layer and the 2 electrode active material layer have a peripheral region and an inner region inside the peripheral region, and the 1 electrode active material layer is laminated only on the inner region.

The second current collector layer is folded so as to enclose the electrolyte layer and the second electrode active material layer, and is joined to the first current collector layer via an insulating sealing member to form a joint portion on the peripheral region, thereby sealing the first electrode active material layer, the electrolyte layer, and the second electrode active material layer with the first current collector layer, the insulating sealing member, and the second current collector layer.

### Include.

According to the method of manufacturing a unit cell of the present disclosure, it is possible to provide a unit cell in which the energy density per unit area and the energy density per unit volume are improved. For details of the unit cell manufactured by the method of manufacturing a unit cell of the present disclosure, reference can be made to the description of the unit cell of the present disclosure.

The present disclosure will be described in more detail with reference to the following examples, but the scope of the present disclosure is not limited to these examples.

### Example 1

A positive electrode mixture containing LiNi_{1/3}Co_{1/3}Mn_{1/3} as a positive electrode active material, LiI—LiBr—Li₂S—P₂S₅ as a solid electrolyte, VGCF (gas phase method carbon fiber) as a conductive auxiliary agent, and SBR (styrene butadiene rubber) as a binder was prepared, and a positive electrode active material layer as a first electrode active material layer was obtained from the positive electrode mixture.

Further, a negative electrode mixture containing graphite as a negative electrode active material, LiI—LiBr—Li₂S—P₂S₅ as a solid electrolyte, and SBR as a binder was prepared, and a negative electrode active material layer as a second electrode active material layer was obtained from the negative electrode mixture.

Further, a solid electrolyte mixture containing LiI—LiBr—Li₂S—P₂S₅ as a solid electrolyte and SBR as a binder was prepared, and a solid electrolyte layer as an electrolyte layer was obtained from the solid electrolyte mixture.

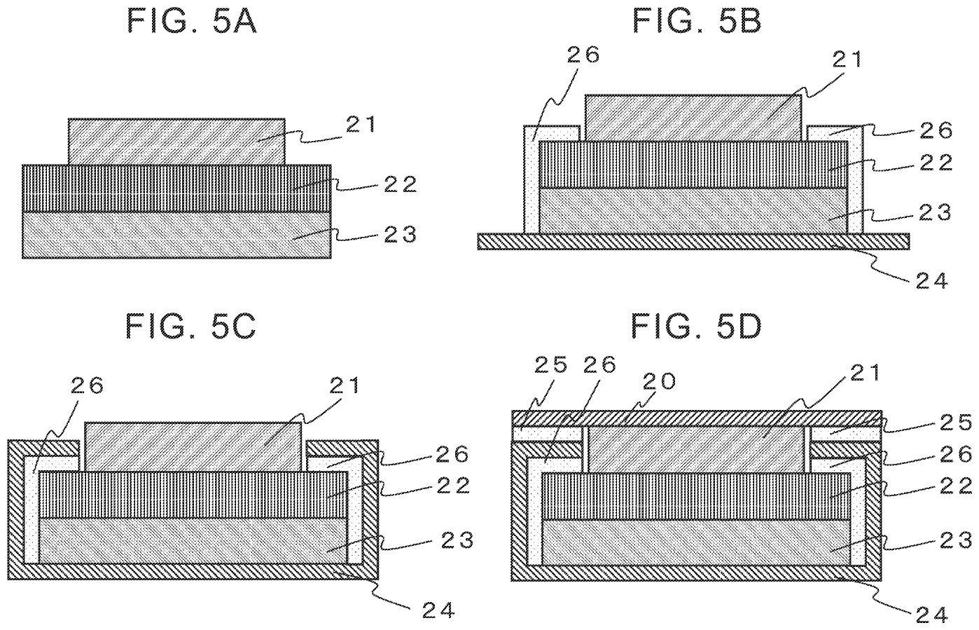

As shown in FIG. 5A, a positive electrode active material layer, a solid-electrolyte layer, and a negative electrode active material layer were laminated to obtain an electrode laminate. The negative electrode active material layer and the solid electrolyte layer had a peripheral region and an inner region inside the peripheral region, and the positive electrode active material layer was laminated only in the inner region of the solid electrolyte layer.

The electrode laminate was disposed on the nickel foil so that the negative electrode active material layer and the nickel foil, which is the second current collector layer, were in contact with each other. As shown in FIG. 5B, PP (polypropylene) films as insulating lashing members were coated from the peripheral regions of the solid-state electrolyte layers to the nickel foil. Then, the whole was heated (150° C. for 1 minute) to temporarily fix the electrode laminate on the nickel foil.

As shown in FIG. 5C, the nickel-foil was bent along PP films, which are insulating lashing members. Next, as shown in FIG. 5D, PP films, which are insulating sealing members, were placed on the bent nickel-foil on the peripheral region. Furthermore, an aluminum foil, which is a first current collector layer, was arranged so as to be in contact with PP films and the positive electrode active material layer arranged in the peripheral region.

Thereafter, the whole was heated (160° C., 1 minute), whereby the nickel foil formed a joint portion with the aluminum foil on the peripheral region, whereby the positive electrode active material layer, the solid electrolyte layer, and the negative electrode active material layer were sealed, and a unit cell in which the exterior body was formed by the first current collector layer and the second current collector layer was obtained. Here, the width of the joint portion was 3 mm, and the thickness of the joint portion was 100% of the total thickness of the first current collector layer and the first electrode active material layer.

While preferred embodiments of the unit cell of the present disclosure have been described, those skilled in the art will appreciate that changes can be made without departing from the scope of the claims.

What is claimed is:

1. A unit cell comprising a first current collector layer, a first electrode active material layer, an electrolyte layer, a second electrode active material layer, and a second current collector layer stacked in this order, wherein:
the electrolyte layer and the second electrode active material layer have a peripheral region and an inside region located inside the peripheral region when viewed in a stacking direction of the layers constituting the unit cell;
the first electrode active material layer is stacked only on the inside region; and
the second current collector layer is folded so as to enclose the electrolyte layer and the second electrode active material layer, and is joined to the first current collector layer via an insulating sealing member on the peripheral region to form a joint portion, thereby sealing the first electrode active material layer, the electrolyte layer, and the second electrode active material layer with the first current collector layer, the insulating sealing member, and the second current collector layer.

2. The unit cell according to claim 1, wherein a thickness of the joint portion of the first current collector layer, the insulating sealing member, and the second current collector layer in the stacking direction is equal to or smaller than a total thickness of the first current collector layer and the first electrode active material layer.

3. The unit cell according to claim 1, wherein the first current collector layer, the insulating sealing member, and the second current collector layer are stacked in the joint portion in an order of the first current collector layer, the insulating sealing member, and the second current collector layer from a side farther from the electrolyte layer.

4. The unit cell according to claim 1, wherein the first current collector layer, the insulating sealing member, and the second current collector layer are stacked in the joint portion in an order of the second current collector layer, the insulating sealing member, and the first current collector layer from a side farther from the electrolyte layer.

5. The unit cell according to claim 1, wherein the electrolyte layer is a solid electrolyte layer.

6. A method of manufacturing a unit cell including a first current collector layer, a first electrode active material layer, an electrolyte layer, a second electrode active material layer, and a second current collector layer stacked in this order, including:
providing a stack of a first current collector layer, a first electrode active material layer, an electrolyte layer, a second electrode active material layer, and a second current collector layer, wherein the electrolyte layer and the second electrode active material layer have a peripheral region and an inside region located inside the peripheral region when viewed in a stacking direction of the layers constituting the unit cell, and the first electrode active material layer is stacked only on the inside region; and
folding the second current collector layer so as to enclose the electrolyte layer and the second electrode active material layer, and joining the second current collector layer to the first current collector layer via an insulating sealing member on the peripheral region to form a joint portion, thereby sealing the first electrode active material layer, the electrolyte layer, and the second electrode active material layer with the first current collector layer, the insulating sealing member, and the second current collector layer.
